(19) United States
(12) Patent Application Publication
(10) Pub. No.: US 2012/0202546 A1
(43) Pub. Date: Aug. 9, 2012

(54) COMMUNICATION SYSTEM, RADIO BASE STATION, AND COMMUNICATION CONTROL METHOD

(75) Inventor: Taku Nakayama, Kanagawa (JP)

(73) Assignee: KYOCERA CORPORATION, Kyoto (JP)

(21) Appl. No.: 13/500,893

(22) PCT Filed: Oct. 8, 2010
(86) PCT No.: PCT/JP2010/067797

§ 371 Date: Apr. 6, 2012

(30) Foreign Application Priority Data
Oct. 9, 2009 (JP) 2009-235755

(51) Int. Cl. H04W 72/08

(52) U.S. Cl. 455/509

(57) ABSTRACT

A radio base station (1A) generates and holds associations each between a resource block and a piece of MIMO information and allocates, based on the associations, a resource block to radio terminals (2A and 2C) in the cell (3A). When the radio terminals (2A and 2C) in the cell (3A) suffers a predetermined level or higher level of interference caused by the communication between another radio base station (1B) and a radio terminal (2B) that exists in the cell (3B) of the other radio base station (1B), the radio base station (1A) selects one of the associations each between a resource block and a piece of MIMO information and allocates, based on the selected association, a resource block to the radio terminals (2A and 2C) in the cell (3A).

### TECHNICAL FIELD

The present invention relates to a communication system that performs assignment of a radio resource used for communication between a radio base station and a radio terminal and specified by at least a frequency, a radio base station that performs assignment of a radio resource used for communication with a radio terminal and specified by at least a frequency, and a communication control method in the communication system.

### BACKGROUND ART

In a radio communication system such as LTE (Long Term Evolution) or WiMAX (Worldwide Interoperability for Microwave Access), it is possible for a radio base station to apply an individual MIMO (Multiple Input Multiple Output) scheme and a transmission weight to a radio terminal. Furthermore, it is possible for the radio base station to assign a subframe (a radio resource) to the radio terminal based on a rule such as PF (Propotional Fair).

Basically, the radio terminal expresses a radio wave environment at certain time by SINR (Signal to Interference and Noise power Ratio), and feeds a MIMO scheme and a transmission weight, in which the SINR is estimated to be optimal by the radio terminal itself, back to the radio base station. In this way, the capacity of a space as MOMO is effectively utilized.

Furthermore, the radio terminal feeds back the SINR when the MIMO scheme and the transmission weight to be fed back have been reflected to the radio base station. Meanwhile, the radio base station decides a priority of assignment of a resource block to the radio terminal, a modulation scheme, a coding rate and the like based on the SINR.

### PRIOR ART DOCUMENT

### Non-Patent Document

Non-Patent Document 1: 3GPP TS 36.213 V8.7.0 “Technical Specification Group Radio Access Network; Evolved Universal Terrestrial Radio Access (E-UTRA); Physical layer procedures (Release 8)”

Non-Patent Document 2: 3GPP TS 36.211 V8.7.0 “Technical Specification Group Radio Access Network; Evolved Universal Terrestrial Radio Access (E-UTRA); Physical Channels and Modulation (Release 8)”

### SUMMARY OF THE INVENTION

In the above-mentioned radio communication system, it is assumed, by reason of a short distance between the radio base stations, that there exists an environment in which a ratio of power of an interference wave with respect to power of a desired wave is large. Under such an environment, if each radio base station assigns a resource block to a radio terminal, which has been connected to the radio base station itself, based on feedback information from the radio terminal, it is considered that a MIMO scheme and a transmission weight corresponding to the resource block are frequently changed depending on a communication state in the radio terminal to which the resource block is to be assigned.

As described above, if the MIMO scheme and the transmission weight are frequently changed, it is considered that a radiation pattern uniquely specified by the MIMO scheme and the transmission weight and indicating a radio signal arrival range is also frequently changed. Moreover, the radiation pattern is significantly changed, so that interference received by another radio terminal connected to another radio base station is also frequently changed and thus a radiation pattern in the other radio base station is frequently changed.

As described above, if a radio terminal connected to one radio base station and another radio terminal connected to the other radio base station receive mutual interference frequently changed, even when a resource block is assigned to the radio terminal based on feedback information from the radio terminal, since communication using the resource block satisfies predetermined quality for a short period, it is probable that communication is difficult in a short period.

Therefore, the present invention has been achieved in view of the above-described problems, and an object thereof is to provide a communication system capable of appropriately assigning a radio resource by suppressing a frequent change in interference, a radio base station, and a communication control method.

To solve the above problem, the present invention has following features. A first feature of the present is summarized as a communication system (radio communication system 10) that performs assignment of a radio resource (resource block) used for communication between a radio base station (radio base station 1A) and a radio terminal (radio terminal 2A, 2C) and uniquely specified by at least a frequency, wherein at least one of the radio base station and the radio terminal comprises a plurality of antennas that can change a radiation pattern indicating a radio signal arrival range, and the communication system comprises: a holding unit (storage unit 103) configured to hold an association of the radio resource and the radiation pattern; and an assignment unit (assignment unit 166) configured to assign the radio resource, which is specified by the association held by the holding unit, to the radio terminal, which communicates with a predetermined radio base station, according to a state of interference between the predetermined radio base station and another radio base station.

The above communication system associates a radio resource with a radiation pattern, and assigns the radio resource to a radio terminal based on the association according to the state of interference between a predetermined radio base station and another radio base station. That is, since a relation between the radio resource specified by a frequency and the radiation pattern is fixed, in other words, since a relation between the frequency and the radiation pattern is fixed, a radiation pattern for a predetermined frequency is not frequently changed in a certain radio base station. Consequently, it is possible to suppress a frequent change in interference received by another radio terminal connected to another radio base station, so that it is possible for the other radio terminal to continuously use a radio resource assigned once. Furthermore, the association is used according to interference, so that it is possible to assign a radio resource based on the association as the occasion demands, resulting in a reduction of processing load.

A second feature of the present is summarized as that the holding unit holds the association in which the state of the interference is considered, and when the state of the interference is equal to or more than a predetermined level, the assignment unit assigns the radio resource specified by the association to the radio terminal which communicates with the predetermined radio base station.

A third feature of the present is summarized as that the assignment unit assigns the radio resource, which is required by the radio terminal, to the radio terminal, when the state of the interference is smaller than the predetermined level.

A fourth feature of the present is summarized as that the state of the interference is a state of interference by the radio terminal, which communicates with the predetermined radio base station, from the other radio base station.

A fifth feature of the present is summarized as a radio base station that performs assignment of a radio resource used for communication with a radio terminal and uniquely specified by at least a frequency, wherein at least one of the radio base station and the radio terminal comprises a plurality of antennas that can change a radiation pattern indicating a radio signal arrival range, and the radio base station comprises: a holding unit configured to hold an association of the radio resource and the radiation pattern; and an assignment unit configured to assign the radio resource, which is specified by the association held by the holding unit, to the radio terminal, which communicates with a predetermined radio base station, according to a state of interference between the predetermined radio base station and another radio base station.

A sixth feature of the present is summarized as a communication control method in a communication system that performs assignment of a radio resource used for communication between a radio base station and a radio terminal and uniquely specified by at least a frequency, wherein at least one of the radio base station and the radio terminal includes a plurality of antennas that can change a radiation pattern indicating a radio signal arrival range, and the communication control method comprises: a step of holding, by the communication system, an association of the radio resource and the radiation pattern; and a step of assigning, by the communication system, the radio resource specified by the held association to the radio terminal, which communicates with a predetermined radio base station, according to a state of interference between the predetermined radio base station and another radio base station.

A seventh feature of the present is summarized as a communication control method in a communication system that performs assignment of a radio resource used for communication between a radio base station and a radio terminal and specified by at least a frequency, wherein at least one of the radio base station and the radio terminal includes a plurality of antennas that change a radiation pattern indicating a radio signal arrival range, the communication control method comprises: a step of transmitting information from the radio terminal to the radio base station, wherein the information is information required when the radio base station selects a MIMO scheme corresponding to the radio terminal and forms the radiation pattern corresponding to the MIMO scheme; a step of holding, by the radio base station, an association of the radio resource and the radiation pattern formed based on the information; and a step of assigning, by the radio base station, the radio resource specified by the held association to the radio terminal according to a state of interference between the radio base station and another radio base station.

According to the present invention, it is possible to suppress a frequent change in interference.

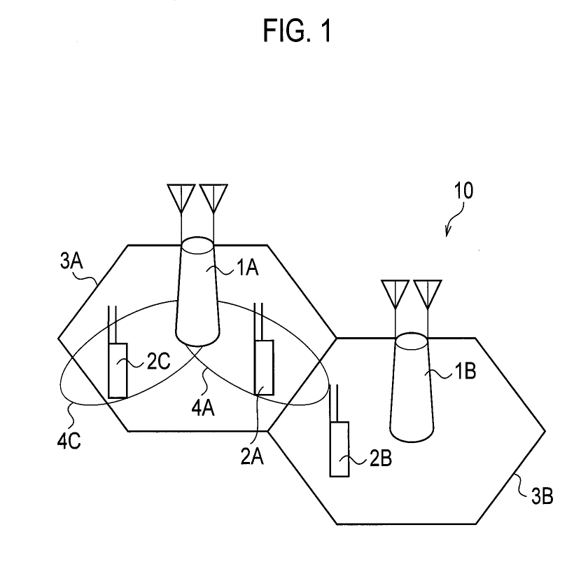

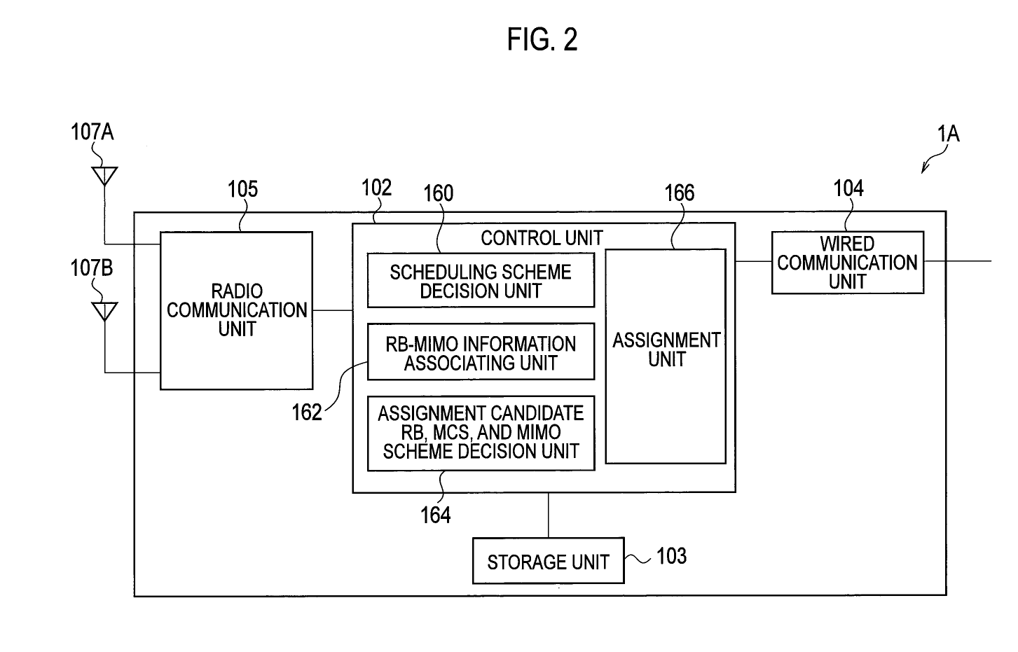

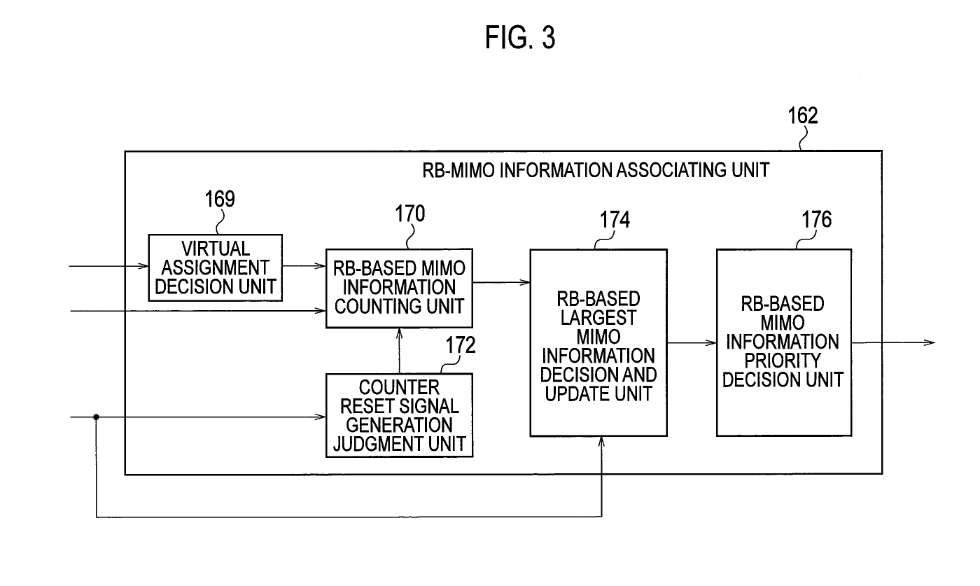

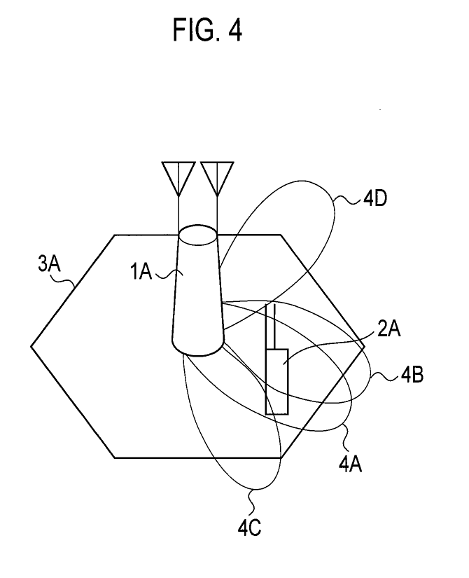

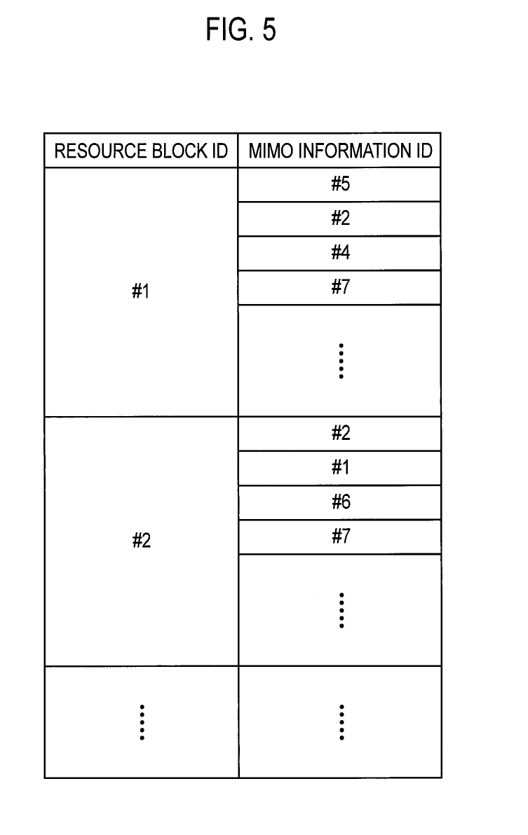

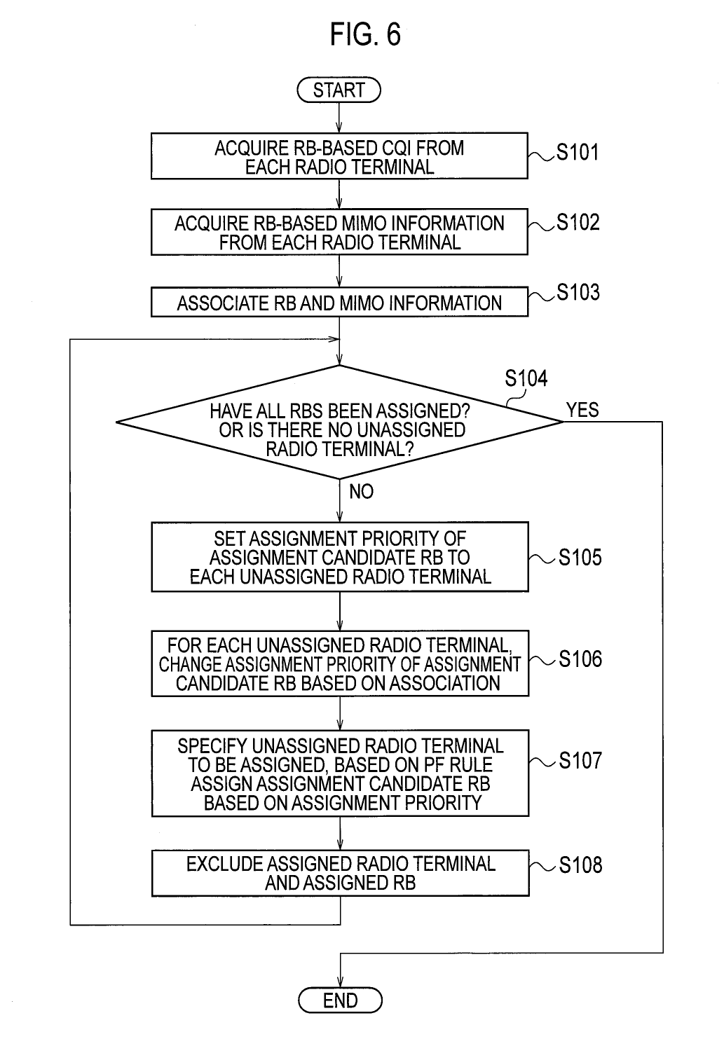

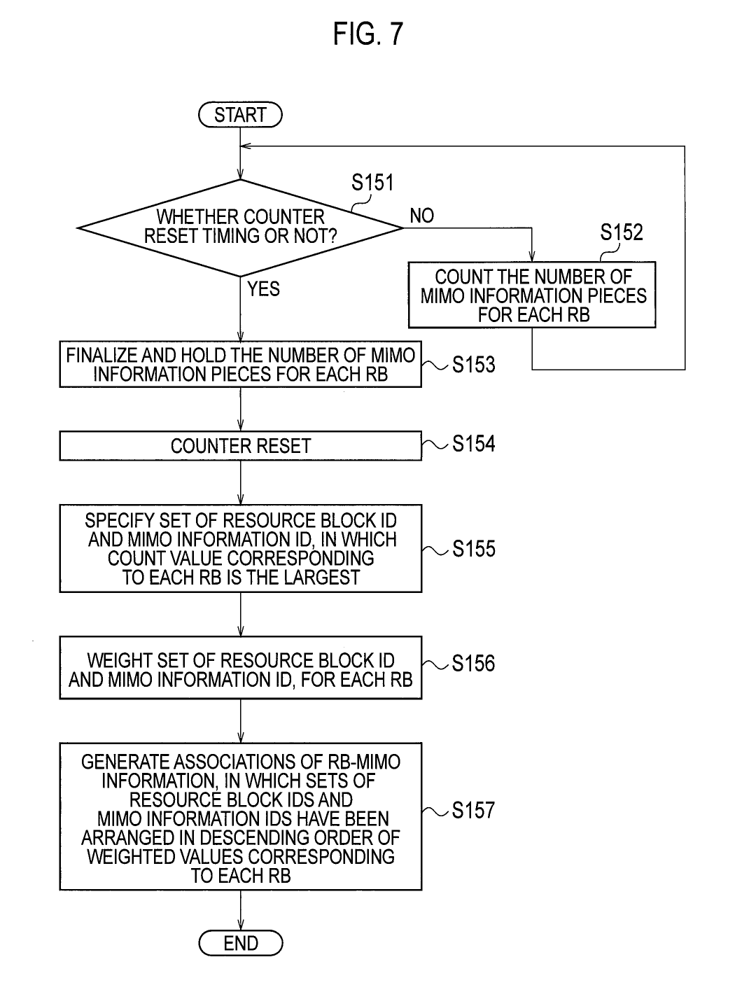

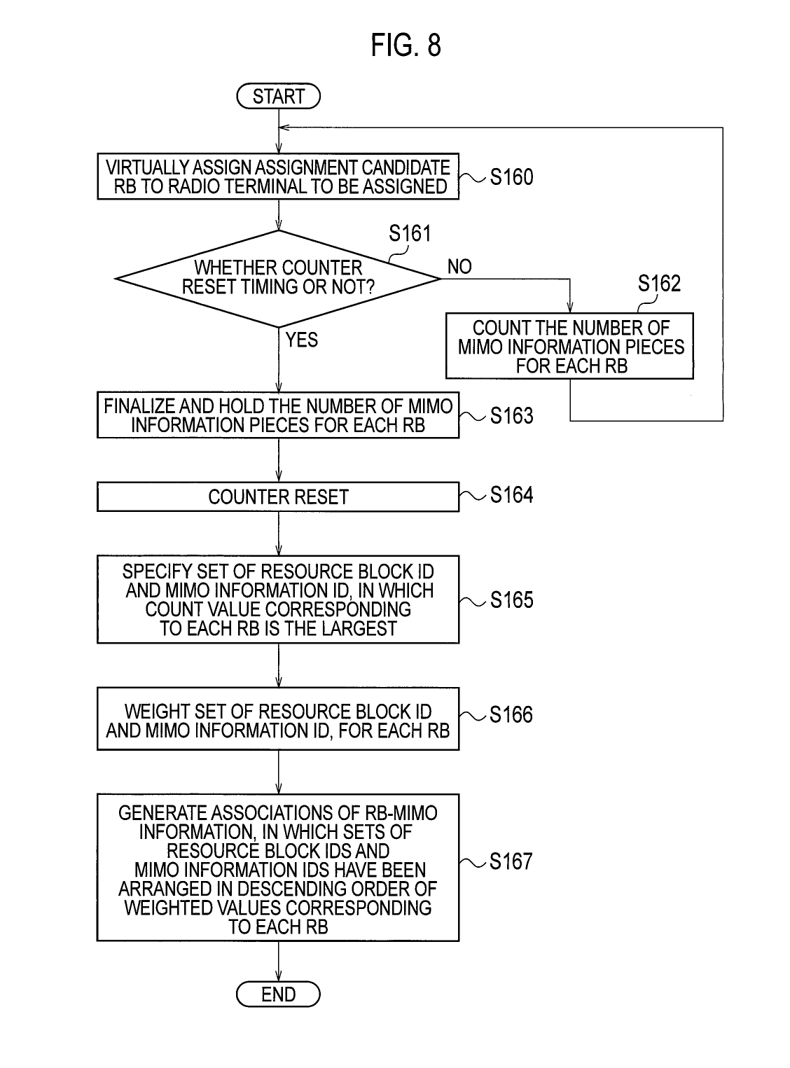

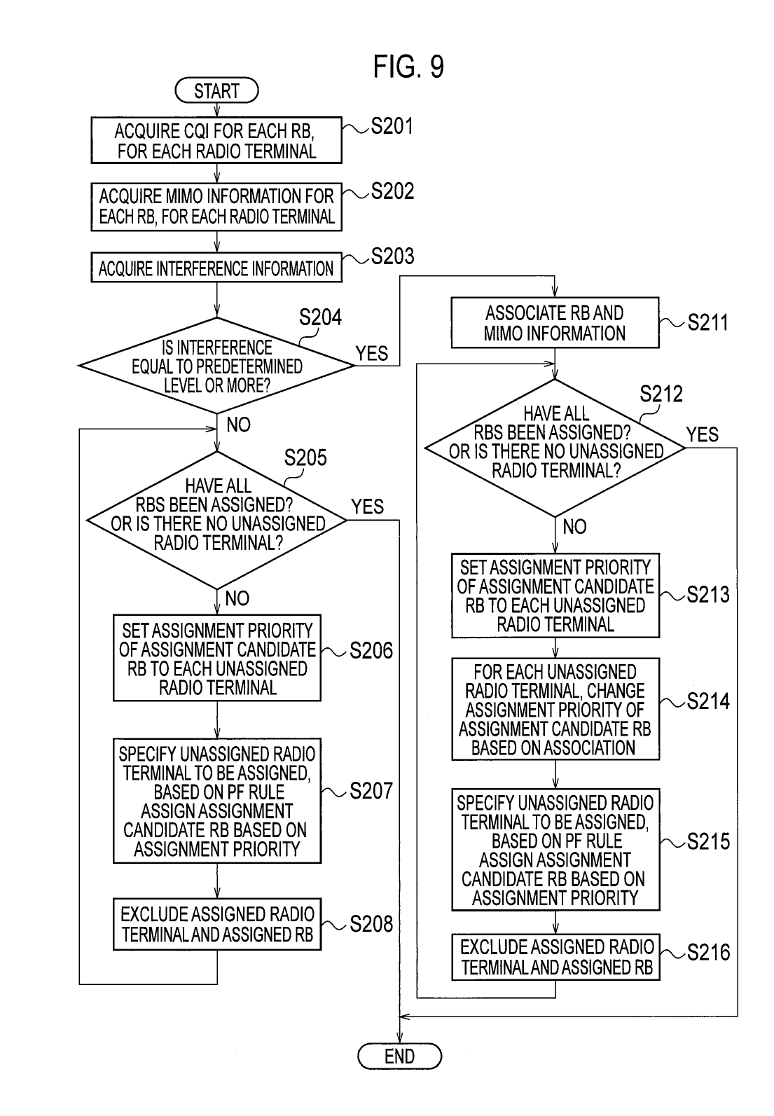

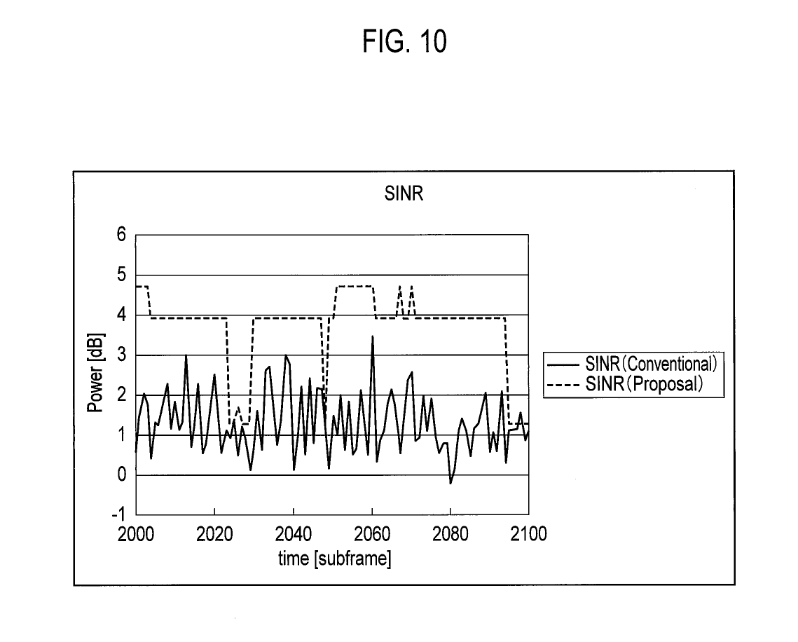

### BRIEF DESCRIPTION OF THE DRAWINGS

[FIG. 1] FIG. 1 is a diagram showing the entire schematic configuration of a radio communication system according to an embodiment of the present invention.

[FIG. 2] FIG. 2 is a configuration diagram of a radio base station according to the embodiment of the present invention.

[FIG. 3] FIG. 3 is a configuration diagram of an RB-MIMO information associating unit according to the embodiment of the present invention.

[FIG. 4] FIG. 4 is a diagram illustrating an example of a radiation beam in the radio base station according to the embodiment of the present invention.

[FIG. 5] FIG. 5 is a diagram illustrating an example of the associations of RB-MIMO information according to the embodiment of the present invention.

[FIG. 6] FIG. 6 is a flowchart illustrating a first operation in which the radio base station assigns a resource block according to the embodiment of the present invention.

[FIG. 7] FIG. 7 is a flowchart illustrating a first operation for generating the associations of resource blocks and MIMO information according to the embodiment of the present invention.

[FIG. 8] FIG. 8 is a flowchart illustrating a second operation for generating the associations of resource blocks and MIMO information according to the embodiment of the present invention.

[FIG. 9] FIG. 9 is a flowchart illustrating a second operation in which the radio base station assigns a resource block according to the embodiment of the present invention.

[FIG. 10] FIG. 10 is a diagram illustrating SINRs according to the conventional art and the present embodiment.

### MODES FOR CARRYING OUT THE INVENTION

Hereinafter, an embodiment of the present invention will be described with reference to the accompanying drawings. Specifically, the embodiment of the present invention will be described in sequence of (1) Configuration of radio communication system, (2) Operation of radio base station, (3) Operation and effect, and (4) Other embodiments. In all drawings for explaining the following embodiments, the same or similar reference numerals are used to designate the same or similar elements.

### (1) Configuration of Radio Communication System

### (1.1) Entire Schematic Configuration of Radio Communication System

FIG. 1 is a diagram showing the entire schematic configuration of a radio communication system 10 according to an embodiment of the present invention.

The radio communication system 10 illustrated in FIG. 1 has a configuration based on LTE (Long Term Evolution) which is a standard designed in 3GPP. The radio communication system 10 includes radio base stations 1A and 1B provided with two antennas, and radio terminals 2A, 2B, and 2C provided with two antennas.

In FIG. 1, the radio terminals 2A and 2C exist in a cell 3A formed by the radio base station 1A. Furthermore, the radio terminal 2B exists in a cell 3B formed by the radio base station 1B. The radio base station 1A communicates with the radio terminals 2A and 2C existing in the cell 3A. At this time, the radio base station 1A forms radiation patterns 4A and 4C which indicate a radio signal arrival range. Furthermore, the radio base station 1B communicates with the radio terminal 2B existing in the cell 3B.

### (1.2) Configuration of Radio Base Station

FIG. 2 is a diagram illustrating the configuration of the radio base station 1A. The radio base station 1A illustrated in FIG. 2 includes a control unit 102, a storage unit 103, a wired communication unit 104, a radio communication unit 105, and antennas 107A and 107B. In addition, the radio base station 1B also has the same configuration as that of the radio base station 1A.

The control unit 102, for example, includes a CPU and controls various functions of the radio base station 1A. The storage unit 103, for example, includes a memory and stores various types of information used for control and the like of the radio base station 1. The wired communication unit 104 is connected to a backbone network (not illustrated) through a router and the like (not illustrated). The radio communication unit 105 receives radio signals from the radio terminals 2A and 2C and transmits radio signals to the radio terminals 2A and 2C using a MIMO scheme via the antennas 107A and 107B.

Next, detailed control of the control unit 102 will be described. The control unit 102 assigns a resource block (RB), which is a radio resource, to the radio terminals 2A and 2C. As illustrated in FIG. 2, the control unit 102 includes a scheduling scheme decision unit 160, an RB-MIMO information associating unit 162, an assignment candidate, MCS, and MIMO scheme decision unit 164, and an assignment unit 166.

In a general MIMO configuration in the LTE Release 8, the radio base station 1A is provided with the two transmitting antennas 107A and 107B, and the radio terminals 2A and 2C are provided with two receiving antennas, respectively. In the 2×2 configuration, the radio base station 1A decides a MIMO scheme with respect to the radio terminals 2A and 2C. Specifically, the control unit 102 of the radio base station 1A decides a MIMO scheme from Open Loop MIMO, which indicates MIMO information including only RI (Rank Indicator: spatial multiplexing information) fed back from the radio terminals 2A and 2C, and Closed Loop MIMO which indicates MIMO information including the RI and PMI (Precoding Matrix Indicator: index information of a transmission weight) fed back from the radio terminals 2A and 2C.

Furthermore, in the Open Loop MIMO, it is possible for the control unit 102 of the radio base station 1A to select two types of MIMO schemes called SFBC and LCDD by the RI. In the Closed Loop MIMO, it is possible for the control unit 102 of the radio base station 1A to select four types of PMIs when the RI=1, and two types of PMIs when the RI=2. If all these are considered, eight MIMO schemes corresponding to the radio terminals 2A and 2C in the 2×2 configuration are selectable.

In these MIMO schemes, the antennas 107A and 107B of the radio base station 1A transmit signals based on a predetermined rule. In this way, corresponding radiation patterns are formed. Among the radiation patterns formed by the radio base station 1A, a radiation pattern, in which gain is obtained in the radio terminals 2A and 2C in the cell 3A, is selected. In this case, the radiation pattern may cause strong interference or weak interference to the radio terminal 2B in the cell 3B formed by the other radio base station 1B.

The information fed back from the radio terminals 2A and 2C includes information on a communication state in the radio terminals 2A and 2C, in addition to the above-mentioned MIMO information. One of them is CQI (Channel Quality Indicator) obtained by replacing SINR with bit information. The CQI corresponds to the fed back MIMO information and is CQI when a MIMO scheme and a transmission weight desired by the radio terminals 2A and 2C have been selected, which are included in the MIMO information.

The control unit 102 of the radio base station 1A performs scheduling of assignment of a resource block to the radio terminal 2A, decision of a modulation scheme (MCS), and the like based on the MIMO information and the CQI in order to achieve a target error rate.

As a result of the scheduling, if a change in SINR at a frequency of a resource block assigned to the radio terminals 2A and 2C is small as compared with the case of communication and feedback, communication reaching the target error rate is possible in downlink communication from the radio base station 1A to the radio terminals 2A and 2C.

However, when a resource block with the same frequency as that of the resource block assigned to any one of the radio terminals 2A and 2C is assigned to the radio terminal 2B in the cell 3B formed by the other radio base station 1B, since a radiation pattern corresponding to the resource block is changed, it is probable that interference received by the radio terminals 2A and 2C is also changed. Moreover, the interference received by the radio terminal 2A is changed in each subframe.

In such a case, even when the control unit 102 of the radio base station 1A performs scheduling based on CQIs from the radio terminals 2A and 2C, if SINR corresponding to the CQI at the time of feedback and SINR at the time of actual communication are significantly changed, particularly, if the SINR at the time of actual communication is reduced, since it is not possible to satisfy a required SINR corresponding to the SINR set by the scheduling, communication is not possible.

In consideration of such a problem, the RB-MIMO information associating unit 162 in the control unit 102 of the radio base station 1A associates each resource block with MIMO information including a MIMO scheme and a transmission weight, which indicate information for uniquely specifying a radiation pattern, before scheduling is performed with respect to the radio terminals 2A and 2C. Information on the associations is stored in the storage unit 103.

FIG. 3 is a configuration diagram of the RB-MIMO information associating unit 162. The RB-MIMO information associating unit 162 illustrated in FIG. 3 includes a virtual assignment decision unit 169, an RB-based MIMO information counting unit 170, a counter reset signal generation judgment unit 172, an RB-based largest MIMO information decision and update unit 174, and an RB-based MIMO information priority decision unit 176.

When the assignment candidate RB, MCS, and MIMO scheme decision unit 164, which will be described later, decides a MIMO scheme and a transmission weight for each of the radio terminals 2A and 2C based on the MIMO information from the radio terminals 2A and 2C and decides one or more resource blocks (assignment candidate resource blocks) to be assigned and MCS for each of the radio terminals 2A and 2C based on the CQI of each resource block from the radio terminals 2A and 2C, the virtual assignment decision unit 169 virtually assigns a resource block to the radio terminals 2A and 2C based on the above decision. Moreover, the virtual assignment decision unit 169 outputs MIMO information, which corresponds to the virtually assigned resource block, to the RB-based MIMO information counting unit 170.

The RB-based MIMO information counting unit 170 receives MIMO information of each resource block (each frequency) from the radio terminals 2A and 2C in the cell 3A. The received MIMO information includes MIMO information corresponding to a radiation pattern required by the radio terminals 2A and 2C at that time point, or MIMO information corresponding to a radiation pattern at the resource block assigned to the radio terminals 2A and 2C at that time point.

Otherwise, the RB-based MIMO information counting unit 170 receives the MIMO information from the virtual assignment decision unit 169.

Next, the RB-based MIMO information counting unit 170 counts the number of inputs of the MIMO information for each resource block and for each different type of MIMO information. Moreover, the RB-based MIMO information counting unit 170 outputs the sets of count values, identification information (resource block IDs) of corresponding resource blocks, and identification information (MIMO information IDs) of corresponding MIMO information to the RB-basedbased largest MIMO information decision and update unit 174.

A signal (a time cycle signal) is input to the counter reset signal generation judgment unit 172 in a predetermined time cycle. Here, the predetermined time cycle is longer than a time corresponding to one subframe which is a variation cycle of interference.

When the time cycle signal is input, the counter reset signal generation judgment unit 172 outputs a reset signal to the RB-basedbased MIMO information counting unit 170. When the reset signal is input, the RB-basedbased MIMO information counting unit 170 finalizes count values of the MIMO information. Moreover, the RB-basedbased MIMO information counting unit 170 allows the storage unit 103 to hold the sets of the finalized count values, the resource block IDs of the corresponding resource blocks, and the MIMO information IDs of the corresponding MIMO information. Then, the RB-basedbased MIMO information counting unit 170 resets the count values.

The RB-basedbased largest MIMO information decision and update unit 174 reads the sets of the count values, the resource block IDs, and the MIMO information IDs from the storage unit 103. Moreover, the time cycle signal is input to the RB-basedbased largest MIMO information decision and update unit 174 with the predetermined time cycle. When the time cycle signal is input, the RB-basedbased largest MIMO information decision and update unit 174 specifies a set, in which a corresponding count value is the largest, to each resource block among the sets of the resource block IDs and the MIMO information IDs. Moreover, the RB-basedbased largest MIMO information decision and update unit 174 outputs the set of the resource block ID and the MIMO information ID, in which the corresponding count value is the largest for each resource block, and the set of the resource block ID and the MIMO information ID, in which the corresponding count value is not the largest for each resource block, to the RB-basedbased MIMO information priority decision unit 176.

The RB-basedbased MIMO information priority decision unit 176 receives the set of the resource block ID and the MIMO information ID in which the corresponding count value is the largest for each resource block, and the set of the resource block ID and the MIMO information ID in which the corresponding count value is not the largest for each resource block. Next, the RB-basedbased MIMO information priority decision unit 176 specifies a radiation pattern (a first radiation pattern) uniquely specified by MIMO information corresponding to the MIMO information ID in the set of the resource block ID and the MIMO information ID in which the corresponding count value is the largest, and specifies a radiation pattern (a second radiation pattern) uniquely specified by the MIMO information corresponding to the MIMO information ID in the set of the resource block ID and the MIMO information ID in which the corresponding count value is not the largest.

Moreover, the RB-based MIMO information priority decision unit 176 sets weights to the sets of the resource block IDs and the MIMO information IDs. Specifically, the RB-based MIMO information priority decision unit 176 sets the largest value of the weights to the set of the resource block ID and the MIMO information ID corresponding to the first radiation pattern, and sets weighted values to the sets of the resource block IDs and the MIMO information IDs corresponding to the second radiation pattern such that the weighted values are large values (lower than the largest value) as the shape and the radiation direction of the corresponding second radiation pattern are close to the shape and the radiation direction of the first radiation pattern.

For example, the case will be considered, in which radiation patterns 4A to 4D exist, the first radiation pattern is expressed by 4A, and the second radiation patterns are expressed by 4B, 4C, and 4D as illustrated in FIG. 4. In this case, large weighted values are set to the sets of the resource block IDs and the MIMO information IDs corresponding to the second radiation patterns in an order in which the shapes and the radiation directions of the second radiation patterns are close to the shape and the radiation direction of the first radiation pattern 4A.

Moreover, for each resource block, the RB-based MIMO information priority decision unit 176 sets the highest rank including the set of the resource block ID and the MIMO information ID in which the corresponding count value is the largest, and generates the associations of RB-MIMO information, which is arranged after the second position in an order of corresponding weighted values, for the set of the resource block ID and the MIMO information ID in which the corresponding count value is not the largest. The associations of RB-MIMO information are generated and updated with an input cycle of the time cycle signal.

FIG. 5 is a diagram illustrating an example of the associations of RB-MIMO information. In FIG. 5, MIMO information IDs corresponding to a resource block ID #1 are arranged in an order of MIMO information IDs #5, #2, #4, and #7. Furthermore, MIMO information IDs corresponding to a resource block ID #2 are arranged in an order of MIMO information IDs #2, #1, #6, and #7.

In addition, the RB-based MIMO information priority decision unit 176 may also generate only the set of the resource block ID and the MIMO information ID corresponding to the first radiation pattern as the association of RB-MIMO information.

Returning to FIG. 2, the explanation continues. The scheduling scheme decision unit 160 acquires information on interference received by the radio terminals 2A and 2C through communication with the other radio base station 1B and the radio terminal 2B in the cell 3B formed by the radio base station 2B. Here, the interference information may include CQIs generated in correspondence with SINRs measured by the radio terminals 2A and 2C, or a combination of the distance from the radio base station 1A to the other radio base station 1B and the transmission power of the radio base station 1B, wherein the CQIs are transmitted toward the radio base station 1A.

Next, the scheduling scheme decision unit 160 judges whether the interference is equal to or more than a predetermined level. For example, in the case in which the interference information is the CQIs from the radio terminals 2A and 2C, the scheduling scheme decision unit 160 judges that the interference is equal to or more than the predetermined level when the CQIs are equal to or less than a predetermined value, and judges that the interference is smaller than the predetermined level when the CQIs exceed the predetermined value.

Furthermore, in the case in which the interference information is the distance from the radio base station 1A to the other radio base station 1B and the combination of the distance from the radio base station 1A to the other radio base station 1B and the transmission power of the radio base station 1B, the scheduling scheme decision unit 160 determines that the interference is equal to or more than the predetermined level when the combination of the distance and the transmission power satisfies a predetermined condition (for example, a condition indicating a correspondence relation between the distance and the transmission power, in which the transmission power is reduced as the distance is short), and judges that the interference is smaller than the predetermined level when the combination of the distance and the transmission power does not satisfy the predetermined condition.

Moreover, when the interference is equal to or more than the predetermined level, the scheduling scheme decision unit 160 decides resource block assignment having considered the associations of RB-basedMIMO information. Meanwhile, when the interference is smaller than the predetermined level, the scheduling scheme decision unit 160 decides normal resource block assignment in which the associations of RB-basedMIMO information are not considered.

The assignment candidate RB, MCS, and MIMO scheme decision unit 164 decides a MIMO scheme and a transmission weight for each of the radio terminals 2A and 2C based on the MIMO information from the radio terminals 2A and 2C, and decides one or more resource blocks (assignment candidate resource blocks) to be assigned and MCS for each of the radio terminals 2A and 2C based on the CQI of each resource block from the radio terminals 2A and 2C.

The assignment unit 166 assigns a resource block to each of the radio terminals 2A and 2C. Specifically, the assignment unit 166 sets the assignment priorities of the decided assignment candidate resource blocks to each of the radio terminals 2A and 2C. Here, the assignment unit 166 sets the assignment priorities such that the assignment priorities are increased as CQIs of corresponding resource blocks are large.

Next, when the resource block assignment having considered the associations of RB-basedMIMO information has been decided by the scheduling scheme decision unit 160, the assignment unit 166 reads the associations of RB-basedMIMO information from the storage unit 103. Moreover, the assignment unit 166 changes the assignment priorities of the assignment candidate resource blocks based on the associations of RB-basedMIMO information.

Specifically, when corresponding MIMO scheme and transmission weight coincide with the MIMO scheme and the transmission weight, which are included in the MIMO information corresponding to the MIMO information ID, in the associations of RB-basedMIMO information including resource block IDs corresponding to the assignment candidate resource blocks, the assignment unit 166 sets the assignment priorities of the assignment candidate resource blocks to be highest.

Moreover, the assignment unit 166 assigns an unused assignment candidate resource block with the highest assignment priority of the assignment candidate resource blocks to a radio terminal of an assignment object. In addition, when there exist a plurality of unused assignment candidate resource blocks with the highest assignment priority, the assignment unit 166 assigns any assignment candidate resource block to the radio terminal of an assignment object.

Meanwhile, when the normal resource block assignment not having considered the associations of RB-basedMIMO information has been decided by the scheduling scheme decision unit 160, the assignment unit 166 assigns an unused resource block with the highest assignment priority of the assignment candidate resource blocks to the radio terminal of an assignment object.

### (2) Operation of Radio Base Station

FIG. 6 is a flowchart illustrating a first operation in which the radio base station 1A assigns a resource block.

In step S101, the control unit 102 of the radio base station 1A acquires CQI of each resource block from each radio terminal (each of the radio terminals 2A and 2C in FIG. 1) in an own cell (the cell 3A in FIG. 1).

In step S102, the control unit 102 acquires MIMO information of each resource block from each radio terminal in the own cell.

In step S103, the control unit 102 associates the resource blocks with the MIMO information.

FIG. 7 is a flowchart illustrating a first operation for generating the associations of resource blocks and MIMO information.

In step S151, the RB-basedMIMO information associating unit 162 of the control unit 102 judges whether the reset timing of a counter (the RB-basedbased MIMO information counting unit 170) has reached, specifically, a time cycle signal has been input.

When the reset timing of the counter has not reached, the RB-MIMO information associating unit 162 counts the number of the MIMO information pieces (the number of inputs of the MIMO information) for each resource block and each different type of MIMO information in step S152. Then, the RB-MIMO information associating unit 162 repeats operations after the judgment (step S151) regarding whether the reset timing of the counter has reached.

Meanwhile, when the reset timing of the counter has reached, the RB-MIMO information associating unit 162 finalizes the number of the MIMO information pieces of each resource block and allows the storage unit 103 to hold the finalized number in step S153. Moreover, in step S154, the RB-MIMO information associating unit 162 resets the count value of the counter.

Next, in step S155, the RB-MIMO information associating unit 162 specifies the set of a resource block ID and a MIMO information ID, in which a corresponding count value is the largest, based on a counter value immediately before the counter value is reset.

In step S156, the RB-MIMO information associating unit 162 sets the largest weighted value to the set of a resource block ID and a MIMO information ID, which corresponds to the largest count value, based on the counter value immediately before the counter value is reset, and sets weighted values to the sets of a resource block ID and a MIMO information ID, which corresponds to the count values other than the largest value, such that the weighted values are large values (lower than the largest value) as the shape and the radiation direction of a corresponding second radiation pattern are close to the shape and the radiation direction of a first radiation pattern.

In step S157, the RB-MIMO information associating unit 162 generates the associations of RB-MIMO information, in which sets of resource block IDs and MIMO information IDs have been arranged in the descending order of corresponding weighted values, for each resource block.

FIG. 8 is a flowchart illustrating a second operation for generating the associations of resource blocks and MIMO information.

In step S160, the RB-MIMO information associating unit 162 of the control unit 102 virtually assigns an assignment candidate resource block to a radio terminal of an assignment object. Then, operations equal to those of step S151 to step S157 of FIG. 7 are performed.

Returning to FIG. 6, the explanation continues. In step S104, the control unit 102 judges whether all resource blocks have been completely assigned or there exist no radio terminals to which the resource blocks have not been assigned.

When all resource blocks have been completely assigned or there exist no radio terminals to which the resource blocks have not been assigned, a series of operations are ended.

Meanwhile, when all resource blocks have not been completely assigned or there exist the radio terminals to which the resource blocks have not been assigned, the control unit 102 sets the assignment priority of the assignment candidate resource block to each of the radio terminals to which the resource blocks have not been assigned, in step S105.

In step S106, the control unit 102 changes the assignment priority of the assignment candidate resource block for each of the radio terminals, to which the resource blocks have not been assigned, based on the associations of RB-MIMO information.

In step S107, the control unit 102 specifies a radio terminal of a resource block assignment object from the radio terminals, to which the resource blocks have not been assigned, based on a PF rule. Moreover, the control unit 102 assigns any one of the assignment candidate resource blocks to the radio terminal of the resource block assignment object based on the changed assignment priority of the assignment candidate resource block.

In step S108, the control unit 102 excludes the radio terminal, to which the resource block has been assigned in step S107, from the assignment objects, and excludes the resource block assigned in step S107 from the assignment objects.

Then, the operations after the judgment (step S104) regarding whether all resource blocks have been completely assigned or there exist no radio terminals to which the resource blocks have not been assigned are repeated.

FIG. 9 is a flowchart illustrating a second operation in which the radio base station 1A assigns a resource block.

Since the operations of step S201 and step S202 are equal to the operations of step S101 and step S102 of FIG. 6, description thereof will be omitted.

In step S203, the control unit 102 acquires information on interference received by each radio terminal (each of the radio terminals 2A and 2C in FIG. 1) in an own cell (the cell 3A in FIG. 1) through communication with another radio base station (the radio base station 1B in FIG. 1) and a radio terminal (the radio terminal 2B in FIG. 1) in a cell (the cell 3B in FIG. 1) formed by the other radio base station.

In step S204, the control unit 102 judges whether the interference corresponding to the acquired interference information is equal to or more than a predetermined level.

When the interference is not equal to or more than the predetermined level, the control unit 102 judges whether all resource blocks have been completely assigned or there exist no radio terminals to which the resource blocks have not been assigned, in step S205.

When all resource blocks have been completely assigned or there exist no radio terminals to which the resource blocks have not been assigned, a series of operations are ended.

Meanwhile, when all resource blocks have not been completely assigned or there exist the radio terminals to which the resource blocks have not been assigned, the control unit 102 sets the assignment priority of assignment candidate resource block to each of the radio terminals to which the resource blocks have not been assigned, in step S206.

In step S207, the control unit 102 specifies a radio terminal of a resource block assignment object from the radio terminals, to which the resource blocks have not been assigned, based on a PF rule. Moreover, the control unit 102 assigns any one of the assignment candidate resource blocks to the radio terminal of the resource block assignment object based on the assignment priority of the assignment candidate resource block.

In step S208, the control unit 102 excludes the radio terminal, to which the resource block has been assigned in step S207, from the assignment objects, and excludes the resource block assigned in step S207 from the assignment objects.

Then, the operations after the judgment (step S205) regarding whether all resource blocks have been completely assigned or there exist no radio terminals to which the resource blocks have not been assigned are repeated.

Meanwhile, when it is judged that the interference is equal to or more than the predetermined level in step S204, the control unit 102 associates the resource blocks with the MIMO information in step S211. The detailed operation for generating the associations of the resource blocks and the MIMO information is equal to the operation illustrated in FIG. 7.

In step S212, the control unit 102 judges whether all resource blocks have been completely assigned or there exist no radio terminals to which the resource blocks have not been assigned.

When all resource blocks have been completely assigned or there exist no radio terminals to which the resource blocks have not been assigned, a series of operations are ended.

Meanwhile, when all resource blocks have not been completely assigned or there exist the radio terminals to which the resource blocks have not been assigned, the control unit 102 sets the assignment priority of assignment candidate resource block to each of the radio terminals to which the resource blocks have not been assigned, in step S213.

In step S214, the control unit 102 changes the assignment priority of the assignment candidate resource block for each of the radio terminals, to which the resource blocks have not been assigned, based on the associations of RB-MIMO information.

In step S215, the control unit 102 specifies a radio terminal of a resource block assignment object from the radio terminals, to which the resource blocks have not been assigned, based on a PF rule. Moreover, the control unit 102 assigns any one of the assignment candidate resource blocks to the radio terminal of the resource block assignment object based on the changed assignment priority of the assignment candidate resource block.

In step S216, the control unit 102 excludes the radio terminal, to which the resource block has been assigned in step S215, from the assignment objects, and excludes the resource block assigned in step S215 from the assignment objects.

Then, the operations after the judgment (step 5212) regarding whether all resource blocks have been completely assigned or there exist no radio terminals to which the resource blocks have not been assigned are repeated.

### (3) Operation and Effect

In the present embodiment, the radio base station 1A generates and holds the associations of resource blocks and MIMO information, and assigns the resource block to the radio terminals 2A and 2C in the cell 3A based on the associations.

That is, the correspondence relation between the resource block specified by the frequency and the radiation pattern specified by the MIMO information is fixed. Thus, in the radio base station 1A, a radiation pattern for a predetermined frequency is not frequently changed. Consequently, interference received by another radio terminal 2B connected to another radio base station 1B is prevented from being frequently changed, so that it is possible for another radio terminal 2B to continuously use a resource block assigned once. Moreover, the other radio base station 1B performs the same control as that of the radio base station 1A, so that interference received by the radio terminals 2A and 2C is prevented from being frequently changed, so that frequent change in interference is prevented in the entire radio communication system 10.

FIG. 10 is a diagram illustrating changes in SINRs according to the conventional art and the present embodiment. As illustrated in FIG. 10, in the present embodiment, the change in the SINR is small.

Furthermore, the radio base station 1A changes the assignment priorities of the assignment candidate resource blocks based on the associations of the resource blocks and the MIMO information, and assigns any one of the assignment candidate resource blocks to the radio terminals 2A and 2C based on the changed assignment priorities.

Consequently, it is possible to appropriately assign resource blocks in consideration of the associations of the resource blocks and the MIMO information.

Furthermore, in the present embodiment, when interference received by the radio terminals 2A and 2C in the cell 3A through communication with another radio base station 1B and the radio terminal 2B in the cell 3B formed by the radio base station 1B is equal to or more than a predetermined level, the radio base station 1A selects any one of the associations of the resource blocks and the MIMO information, and assigns the resource blocks to the radio terminals 2A and 2C in the cell 3A based on the associations.

Only when the interference is equal to or more than the predetermined level, the association of the resource blocks and the MIMO information is selected, and the resource blocks are assigned to the radio terminals 2A and 2C in the cell 3A based on the association, so that it is possible to perform resource block assignment based on the association as the occasion demands, resulting in a reduction of processing load.

Furthermore, in the present embodiment, the radio base station 1A generates the associations of the resource blocks and the MIMO information based on the number of the MIMO information pieces of each resource block from each of the radio terminals 2A and 2C in the cell 3A.

As the number of MIMO information pieces is large, a radiation pattern corresponding to the MIMO information can be regarded as a radiation pattern with a good communication state by radio terminals which are transmission sources of the MIMO information. Consequently, the associations of the resource blocks and the MIMO information are generated based on the number of the MIMO information pieces, so that it is possible to generate the associations having considered the communication state in the radio terminals 2A and 2C.

### (4) Other Embodiments

The present invention has been described with the embodiment. However, it should be understood that those descriptions and drawings constituting a part of the present disclosure do not limit the present invention. From this disclosure, a variety of alternate embodiments, examples, and applicable techniques will become apparent to one skilled in the art.

In the above-mentioned embodiment, the case, in which for resource blocks in the downlink direction, the associations of the resource blocks in the downlink direction and MIMO information are generated and held, and the resource blocks in the downlink direction are assigned based on the associations, has been described. However, the present invention can also be applied in the same manner to the case in which for resource blocks in the uplink direction, the associations of the resource blocks in the uplink direction and MIMO information are generated and held, and the resource blocks in the uplink direction are assigned based on the associations.

Furthermore, in the above-mentioned embodiment, the radio communication system 10 having a configuration based on the LTE has been described. However, the present invention can also be applied in the same manner to radio communication systems having configurations based on other communication standards.

Thus, it must be understood that the present invention includes various embodiments that are not described herein. Therefore, the present invention is limited only by the specific features of the invention in the scope of the claims reasonably evident from the disclosure above.

The entire contents of Japanese Patent Application No. 2009-235755 (filed on Oct. 9, 2009) are incorporated in the present specification by reference.

### INDUSTRIAL APPLICABILITY

The communication system, the radio base station, and the communication control method of the present invention can suppress frequent change in interference, and are available for a communication system and the like.

1. A communication system that performs assignment of a radio resource used for communication between a radio base station and a radio terminal and uniquely specified by at least a frequency, wherein
at least one of the radio base station and the radio terminal comprises a plurality of antennas that can change a radiation pattern indicating a radio signal arrival range, and
the communication system comprises:
a holding unit configured to hold an association of the radio resource and the radiation pattern; and
an assignment unit configured to assign the radio resource, which is specified by the association held by the holding unit, to the radio terminal, which communicates with a predetermined radio base station, according to a state of interference between the predetermined radio base station and another radio base station.

2. The communication system according to claim 1, wherein
the holding unit holds the association in which the state of the interference is considered, and
when the state of the interference is equal to or more than a predetermined level, the assignment unit assigns the radio resource specified by the association to the radio terminal which communicates with the predetermined radio base station.

3. The communication system according to claim 2, wherein the assignment unit assigns the radio resource, which is required by the radio terminal, to the radio terminal, when the state of the interference is smaller than the predetermined level.

4. The communication system according to claim 1, wherein the state of the interference is a state of interference by the radio terminal, which communicates with the predetermined radio base station, from the other radio base station.

5. A radio base station that performs assignment of a radio resource used for communication with a radio terminal and uniquely specified by at least a frequency, wherein
at least one of the radio base station and the radio terminal comprises a plurality of antennas that can change a radiation pattern indicating a radio signal arrival range, and
the radio base station comprises:
a holding unit configured to hold an association of the radio resource and the radiation pattern; and
an assignment unit configured to assign the radio resource, which is specified by the association held by the holding unit, to the radio terminal, which communicates with a predetermined radio base station, according to a state of interference between the predetermined radio base station and another radio base station.

6. A communication control method in a communication system that performs assignment of a radio resource used for communication between a radio base station and a radio terminal and uniquely specified by at least a frequency, wherein
at least one of the radio base station and the radio terminal includes a plurality of antennas that can change a radiation pattern indicating a radio signal arrival range, and
the communication control method comprises:
a step of holding, by the communication system, an association of the radio resource and the radiation pattern; and
a step of assigning, by the communication system, the radio resource specified by the held association to the radio terminal, which communicates with a predetermined radio base station, according to a state of interference between the predetermined radio base station and another radio base station.

7. A communication control method in a communication system that performs assignment of a radio resource used for communication between a radio base station and a radio terminal and specified by at least a frequency, wherein
at least one of the radio base station and the radio terminal includes a plurality of antennas that change a radiation pattern indicating a radio signal arrival range,
the communication control method comprises:
a step of transmitting information from the radio terminal to the radio base station, wherein
the information is information required when the radio base station selects a MIMO scheme corresponding to the radio terminal and forms the radiation pattern corresponding to the MIMO scheme;
a step of holding, by the radio base station, an association of the radio resource and the radiation pattern formed based on the information; and
a step of assigning, by the radio base station, the radio resource specified by the held association to the radio terminal according to a state of interference between the radio base station and another radio base station.
